(19) United States
(12) Patent Application Publication
(10) Pub. No.: US 2024/0112021 A1
(43) Pub. Date: Apr. 4, 2024

(54) AUTOMATIC SPEECH RECOGNITION WITH MULTI-FRAME BLANK DECODING USING NEURAL NETWORKS FOR CONVERSATIONAL AI SYSTEMS AND APPLICATIONS

(71) Applicant: Nvidia Corporation, Santa Clara, CA (US)

(72) Inventors: Hainan Xu, Baltimore, MD (US); Boris Ginsburg, Sunnyvale, CA (US)

(21) Appl. No.: 17/959,958

(22) Filed: Oct. 4, 2022

(51) Int. Cl. G06N 3/08

(52) U.S. Cl. CPC G06N 3/08

(57) ABSTRACT

Systems and methods provide for a machine learning system to train a machine learning model to output a multi-frame blank symbol when processing an auditory input. For example, as the system generates paths through a probability lattice, one or more paths include a multi-frame blank that skips at least one frame associated with the probability lattice. The inclusion of the multi-frame blank symbol may increase a total number of potential paths through the probability lattice, and may allow the machine learning model to more quickly and accurately process audio frames, while disregarding audio frames of less value. In deployment, when an output of the machine learning model indicates a multi-frame blank symbol or token, one or more frames of the auditory input may be omitted from processing.

### BACKGROUND

Conversational artificial intelligence (AI) systems, including various speech-to-text systems, may use implementations of automatic speech recognition (ASR) techniques that are configured to receive an audio input, identify different features from the audio input to predict an associated output text, and then provide a transcription of the audio input. However, when the audio input is broken down into discrete audio frames, many of the individual frames either include no sound or are not helpful in determining any particular feature—such as phonemes, sub words, or letters—associated with the audio input. Processing these empty or unhelpful frames wastes valuable resources and time. As a result, current systems may be slow or expensive to deploy.

### BRIEF DESCRIPTION OF THE DRAWINGS

Various embodiments in accordance with the present disclosure will be described with reference to the drawings, in which:

FIG. 1 illustrates an example environment for a language system, according to at least one embodiment;

FIG. 2 illustrates an example framework for a recurrent neural network transducer, according to at least one embodiment;

FIG. 3 illustrates an example representation of path traversal through a probability lattice, according to at least one embodiment;

FIG. 4 illustrates an example representation of path traversal through a probability lattice, according to at least one embodiment;

FIG. 5A illustrates an example flow chart of a process for generating an output token, according to at least one embodiment;

FIG. 5B illustrates an example flow chart of a process for generating an output token from a trained decoder, according to at least one embodiment;

FIG. 6 illustrates an example flow chart of process for selecting a path associated with an output token, according to at least one embodiment;

FIG. 7 illustrates an example data center system, according to at least one embodiment;

FIG. 8 illustrates a computer system, according to at least one embodiment;

FIG. 9 illustrates a computer system, according to at least one embodiment;

FIG. 10 illustrates at least portions of a graphics processor, according to one or more embodiments; and

FIG. 11 illustrates at least portions of a graphics processor, according to one or more embodiments.

### DETAILED DESCRIPTION

Approaches in accordance with various embodiments overcome the deficiencies of existing and conventional approaches by providing methods and systems that use multi-frame blanks to reduce processing time and resource use for conversational AI systems and applications. In one or more embodiments, a conversational system or application may comprise a neural network that can be used for processing language inputs. In one or more embodiments, the neural network may be trained using a probability lattice that includes a set of frames (t) corresponding to a period of time and different elements (u) for probable outputs. Different probabilities are computed for possible paths through the lattice, with any (e.g., each) path corresponding to a sum of the probabilities of the segments along the path. In existing models, single blanks are used to move through the frames. In contrast, systems and methods of the present disclosure incorporate one or more multi-frame blanks. As a result, two or more blanks can be applied to move through the frames, which generates additional probabilities for computation, and also enables skipping of certain frames. Through training using a probability model (e.g., probability lattice), the neural network is able to automatically decide, by minimizing a loss function, the weights of different token emissions and different paths, some of which include some operations that include both the original blanks and/or the multi-frame blanks. By incorporating multiple blanks, several frames can be skipped and/or not presented for inferencing, thereby reducing a computational load, and increasing speed. In certain embodiments, the training may encourage the use of multiple blanks by under normalizing an output distribution. Additionally, different periods of time during training may use different combinations of under normalization and varying numbers of blanks in order to reduce a number of frames being evaluated. As a result, training can be tuned based on a variety of factors. Various embodiments of the present disclosure combine the multi-frame blank approach during a training phase of an ASR system that may be used for one or more conversational AI systems. The inclusion of the one or more multi-frame blanks may be associated with one or more levels of the ASR system including one or more of a text predictor, an audio encoder, a joint network, linear layers, or software layers.

In deployment, the neural network may output one or more values indicating either a token corresponding to a certain character, phoneme, etc., a token corresponding to a blank, and/or a token corresponding to a multi-frame blank. As such, once trained to compute an output text corresponding to an audio input, the neural network may process frames of the audio data and determine either an output corresponding to audio, or an indication that one or more frames may be skipped before providing another frame to the neural network for processing. As a result, during inference, the neural network processes a subset of the set of frames of the input audio based on determining that one or more frames of the input audio can be skipped (as blanks, or multi-frame blanks) without a decrease in the accuracy or precision of the network. In fact, the results of the network when using multi-frame blanks result in increased accuracy and precision as compared to prior approaches, while also reducing compute and latency of the system.

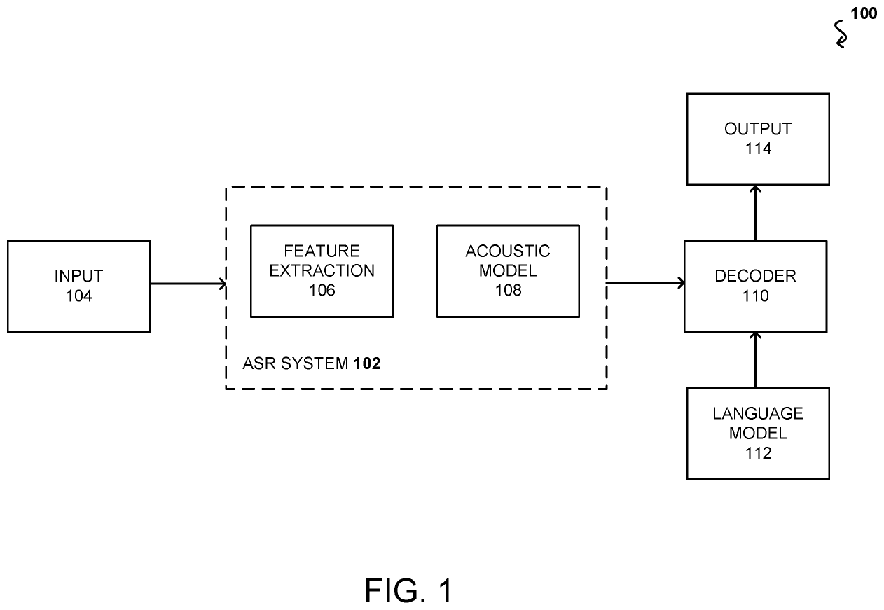

FIG. 1 illustrates an example environment 100 that can be used to provide such functionality in accordance with at least one embodiment. In this example, the environment is associated with an ASR system 102, which may further be incorporated into one or more conversational AI systems, among other options. The conversational system 102 may include one or more different subsets of capabilities that may, as a whole, be referred to as the conversational system 102. The illustrated ASR system 102 is used to generate a prediction for an audio input 104. The audio input 104 may be an utterance from a user, an audio clip, an audio portion extracted from a video, or the like. In various embodiments, the audio input may be a converted input or an input that has been processed or otherwise modified, such as an audio clip that has had portions removed. Using the ASR system 102, speech segmentation, acoustic modelling, and language modelling may be used to form a prediction (of sequences of labels) from noisy, unsegmented input data, such as a user utterance.

In this example, the ASR system 102 includes a feature extraction system 106 and an acoustic model 108. Various other systems and models may be incorporated within, or associated with, the ASR system 102. For example, additional pre or post-processing modules may be included, which are not illustrated here for clarity. In other embodiments, one or more of these components may not be part of the ASR system 102, but may be accessible by or be in communication with the ASR system 102, for example by one or more networks. Moreover, the ASR system 102 may further be integrated into or associated with one or more software developer kits (SDKs) for building speech AI applications, such as Riva from NVIDIA Corporation or with various other deep learning applications, including but not limited to Omniverse from NVIDIA Corporation or DeepStream SDK from NVIDIA Corporation. Additionally, certain features may be integrated into the acoustic model 108, such as one or more decoders. The ASR system 102 may also be associated with, or used along with, a natural language understanding (NLU) or natural language processing (NLP) system. In embodiments, the NLU and/or NLP system may be used with one or more conversational AI systems to allow humans to interact naturally with devices. The NLU and/or NLP system may be a framework or pipeline that receives, processes, and evaluates different portions of the input 104. For example, the input 104 may be pre-processed and/or post-processed, which may include tokenization, lemmatization, stemming, and other processes, as noted herein, which may be part of or separate from the NLU and/or NLP system. Additionally, the NLU and/or NLP system may include one or more deep learning models, such as a bidirectional encoder representations from transformers (BERT) model, to support features such as entity recognition, intent recognition, sentiment analysis, and others. Furthermore, the NLU and/or NLP system may allow for conversion of linguistic units of the input 104 into phonemes, which may then be assembled together, such as by using one or more prosody models.

In at least one embodiment, the feature extraction system 106 may be used for audio signal preprocessing using normalization, windowing, and/or the like. The feature extraction system 106 may also be used to split or otherwise segment different portions of the input 104. For example, feature extraction may include splitting or otherwise dividing the audio input into one or more frames (e.g., time frames), where each frame may correspond to a portion of the audio input such that a set of frames (t) forms a total number of frames (7) corresponding to the audio input and/or to a particular portion of the audio input.

In this example, the acoustic model 108 is a Recurrent Neural Network Transducer (RNN-T). The RNN-T may include an audio encoder to encode sequences of audio features into audio embeddings. In at least one embodiment, long short-term memory (LSTM) or bidirectional long short term memory (B-LSTM) transformers are used as audio encoders. The RNN-T may also include a text predictor to encode a transcript into a text embedding. The text predictor may also use an LSTM. A joiner may be used to combine the output of both the audio encoder and the text predictor for further processing at a linear layer followed by a softmax to produce a probability distribution over output units.

As shown, results of the ASR system 102 are provided to a decoder 110 that may use features from a language model 112 to generate an output 114, which may include a textual output corresponding to the audio input 104. In this manner, a user may interact with a computer system by providing an audio utterance which can be converted to a textual input for downstream use, such as use within a different system of the NLU or NLP system, or provided back to the user for review as a textual output.

Various embodiments of the present disclosure modify one or more portions of an RNN-T in order to incorporate a multi-frame blank training process. With an RNN-T, emission of a blank symbol may consume exactly one input frame. Embodiments of the present disclosure introduce one or more (e.g., multi-) blank symbols in addition to or alternatively from the existing single blank symbol, and those added blank symbols, when emitted, advance the input by more than one frame. Inclusion of the additional blanks may provide improved speed due to the elimination of various models from inferencing. As such, the model is trained, using the probability representation (e.g., lattice) to output probabilities or confidences for a set of characters, symbols, phonemes, etc., in addition to a single blank, a multi-blank, another bigger multi-blank, etc. For example, the model may be trained to output a single blank token, a double blank token, a triple blank token, a quadruple blank token, and/or so on. In some embodiments, depending on the implementation, the model may be trained for different blank values. For non-limiting examples, one model may be trained to use a single blank and a quadruple blank, while another model (e.g., deployed in a different use case) may be trained to use a double blank and a triple blank, or just a double blank. In either situation, using multi-blanks may be prioritized during training such that the accuracy and precision of the network is improved, while the compute resource requirements and latency are reduced (e.g., because less frames may be processed by the network, as one or more frames are skipped for each blank or multi-blank).

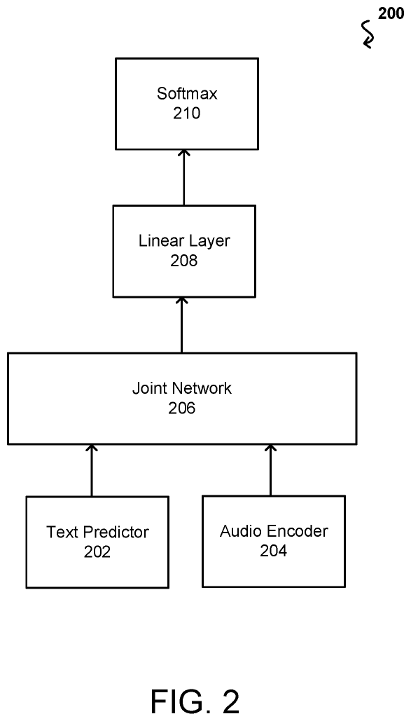

An RNN-T model consists of an acoustic encoder, a decoder (which may be referred to as a label encoder), and a joint network (also referred to as a joiner). The acoustic encoder converts the input acoustic features into a higher level representation, and the decoder converts the history context information at the label side. The joint network combines the output of the encoder and the decoder and outputs a probability distribution over the vocabulary and the one or more blank-related tokens (e.g., a single blank token, a multi-frame blank token, etc.). FIG. 2 illustrates an example framework 200 of an RNN-T including a text predictor 202 and an audio encoder 204. The joint network 206, as noted herein, may combine the outputs of both the text predictor 202 and the audio encoder 204 for further processing, for example using a linear layer 208 and a softmax layer 210 to generate a probability distribution over output units. In one or more embodiments, the probability may be presented by Pr(k|t, u)(p^{k}_{(t,u)} as representing the probability of emitting “k” from (t,u).

In this example, the RNN-T is an end-to-end model that may not need alignment information during training of the model. In the RNN-T framework, a label sequence could be augmented by adding an arbitrary number of blanks to any position of the sequence, and during RNN-T model training, for any input sequence, the model tries to maximize the probability sum over all augmented sequences of the correct labels. A final layer of the RNN-T model may output the probability distribution over the character, word, sub word, phoneme tokens, etc., as well the blank-related tokens. In this way, when an output is a blank token, or a multi-blank token, a component that prepares the input for the RNN-T model may determine which frames of the input audio to skip and which frame to input to the model next—e.g., skip the next frame for a single blank, skip two frames for a double blank, etc.

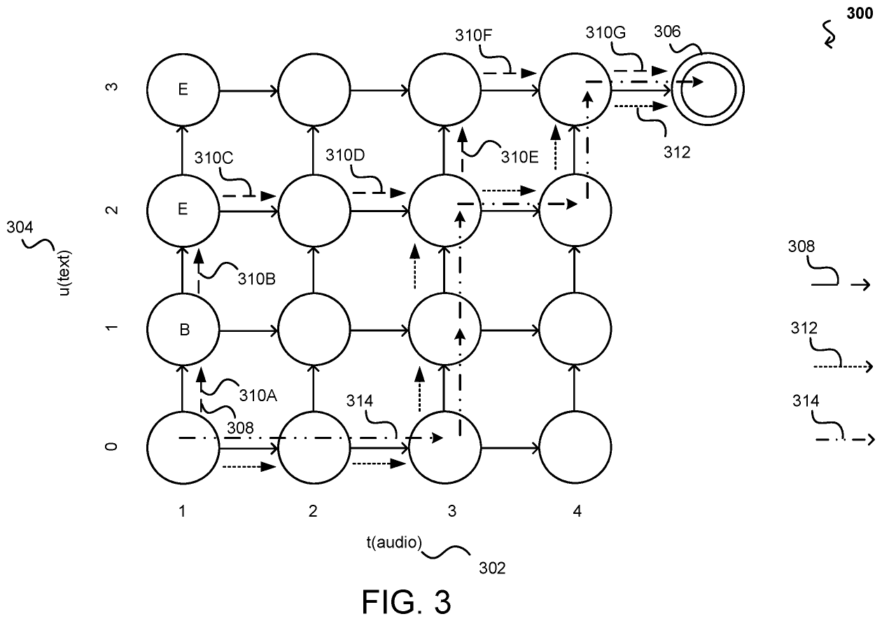

FIG. 3 illustrates an example probability lattice 300 corresponding to a training sequence for an RNN-T. In this example, a training input may include a set of frames 302, shown as four frames 1-4 along the x-axis, labeled as t. Additionally, a number of output units (u) 304 are positioned along the y-axis, with the output units being labeled 0-3, where 0 is the null state before any outputs have been emitted. The illustrated lattice 300 is a 4×4 lattice, but any number of frames or output units may be used with various embodiments and the 4×4 lattice is provided only as an example.

In this example, the audio input may be “bee” which is broken down into output units of [B], [E], and [E], where [B] corresponds to 1, [E] corresponds to 2, and [E] corresponds to 3 along the respective output units 304. The output units represent probabilities that a given letter, sub word, sound, phoneme, etc. is at a particular position. For example, in this case, the output unit at (1,1) is the probability that [B] is at the output unit. During training, the system learns a path through the lattice to move from (1,0) to an end location 306. A loss function may be used to try and shorten or otherwise find a most-efficient path through the lattice.

In at least one embodiment, a first path 308 (represented by a large dash line) is shown that travels from (1,0) to the end location 306. There are multiple steps 310 along the first path 308, which may include “vertical” movement (movement between different output units) and “horizontal” movement (movement between different frames). The starting location corresponds to (1,0) and an output arrow along a first segment 310A represents an associated probability of emitting [B] that may be represented as P^{B}_{(1,0)}. As such, the first segment 310A represents the probability that [B] will be emitted during the first frame.

The first segment 310A of the first path 308 shows movement from the starting location, corresponding to (1,0), to the first output unit (1,1), which also has an output arrow that has an associated probability of emitting [E], represented as P^{B}_{(1,1)}. In this example, because [B] is found at the output unit labeled as 1, the system may then look for probabilities of [E]. The second segment 310B moves from (1,1) to (1,2), with the associated probability of emitting [E] represented as P^{E}_{(1,2)}.

In the next segment 310C, there is movement between blanks or pauses, which are often present between different letters or sounds in utterances. For example, a letter or phoneme may be predictable after only a portion is heard, and therefore, the remaining frames after that prediction, or between predictions, may be referred to as “blanks.” Blanks may not only refer to pauses or no sounds, but may also include frames with sound that do not differ (at least significantly) from or change a prediction associated with a previous frame. The next segment 310C moves over to the second frame (2) at the output unit 2 to the position (2,2) within the lattice, which evaluates the probability of emitting a blank, that may be represented as P^{blank}_{(1,2)}. The next segment 310D may also evaluate the probability of emitting a blank, that may be represented as P^{blank}_{(2,2)}, within the next frame and move over to (3,2). At (3,2), the path moves again along the y-axis such that a segment 310E is represented with the probability of emitting [E]. Additionally, another segment 310F moves to the next frame (4) and subsequently over to the end location 306 at segment 310G.

As the system walks through this first path 308, there are a total of 7 segments to move from (1,0) to the end location 306. Each of these segments will have an associated probability that may be summed to generate a total probability for the first path 308. Along the path, there were both output units as well as blanks. Identifications of blanks lead to an output that is processed at inference, but that does not lead to an actual output to identify the input utterance, thereby using time and resources for blanks that are unlikely to provide a desired response. This is undesirable and may cause certain systems to be prohibitively expensive for use, especially in on-demand or real-time (or near real-time) applications where speed and resources are at a premium. Even identifying an alternative path, such as a second path 312 (represented by the small dashed line), there are still 7 segments between the start location at (1,0) and the end location 306. This second path 312 will also have a total probability that includes a sum of the probabilities along each segment. Embodiments of the present disclosure address limitations in existing systems by adding in multiple blanks that may span more than one frame. As a result, fewer frames are sent for processing at inference. As such, more efficient paths (e.g., paths with lower losses) may be identified because the multi-frame blanks may allow for creation of additional paths through the lattice, which will have an associated probability that may be more efficient (e.g., have a lower loss) than paths that do not use the multi-frame blanks.

Various embodiments of the present disclosure improve the “horizontal” movement through the lattice between different frames corresponding to blank emissions. Blanks may be referred to as a “standard blank” corresponding to a single frame, a “big blank” corresponding to two frames, and a “bigger blank” corresponding to three or more frames. This terminology is provided by way of example and is not intended to limit the scope of the present disclosure. For example, both a “big blank” and a “bigger blank” are both within the scope of a “multi-frame blank” at least because both the “big blank” and the “bigger blank” each include two or more blanks, as opposed to the exactly one frame of a standard blank. That is, a multi-frame blank allows for movement between multiple frames while a standard blank only provides movement to a next blank in a sequence. Embodiments may further refer to these multi-frame blanks as “multi-frame blank symbols” or “multi-blank symbols” to refer to symbols that, when emitted, advance t by more than one. While embodiments may describe the additional blanks in terms of a single additional blanks, the multi-frame blank symbols described herein may include m number of blanks, where m is two or more. Accordingly, a multi-frame blank symbol may include 2 blanks, 3 blanks, 4 blanks, 5 blanks, 10 blanks, 15 blanks, or any reasonable number of blanks. Additionally, the multi-frame blank symbol may be dynamic and change over time, such that for a first time period m may be equal to a first number—e.g., 2, and for a second time period m may be equal to a second number—e.g., 3. The number of blanks used may refer to advances in time, since a single standard blank may correspond to one frame, two blanks m would correspond to two frames, and so forth. A frame, as described herein, may correspond to any length of audio data, such as 10 milliseconds (ms), 20 ms, 35 ms, 1 second, etc.

A third path 314 (represented by the dash and dot line) is illustrated in FIG. 3 incorporating a multi-frame blank symbol where m is equal to 2. As shown, the initial segment of the third path 314 skips directly from (1,0) to (3,0), thereby removing the processing of frame 2. Removing the processing of frame 2 may also eliminate the probability associated with emission of the blank between (1,0) and (2,0), which may generate a lower path probability that may correspond to lower cost. Accordingly, a more efficient path through the lattice may be identified by selectively choosing when to incorporate the multi-frame blank symbols. The selection of the multi-frame blank symbol may be learned by the system and deployed during evaluation to provide a reduced number of frames for inferencing, which may reduce both time and resource use to process a given input.

In certain embodiments, a forward-backward algorithm is incorporated with an RNN-T that includes both forward weights (α) and backward weights (β), which are represented as:

α(t,u)=α(t−1,u)ø(t−1,u)+α(t,u−1)γ(t,u−1)

β(t,u)=β(t+1,u)ø(t,u))+β(t,u+1)γ(t,u)

However, the addition of the multi-frame blank symbol adds an extra term to the forward and backward weights to correspond to the added symbol, where the modifications are represented as:

α(t,u)=α(t−1,u)ø(t−1,u)+α(t,u−1)γ(t,u−1)+α(t−m,u)øₘᵤₗₜᵢ(t−m,u)

β(t,u)=β(t+1,u)ø(t,u))+β(t,u+1)γ(t,u)+β(t+m,u)øₘᵤₗₜᵢ(t+m,u)

Moreover, boundary cases may have particular conditions for consideration. For example, where t<m for the forward weights or t+m≥T for the backward weights, then multi-frame blank weight should be omitted.

The forward weights correspond to the sum of all possible paths to get to a given point in the lattice from the start. The backward weights correspond to all possible paths from a given node to the end. For example, given the node (3,1) in the lattice, the forward weights would evaluate the possible paths from (1,0) to (3,1), which may include paths such as: (1,0)→(2,0)→(3,0)→(3,1). Another path may include: (1,0)→(1,1)→(2,1)→(3,1). By adding the multi-frame blank symbols, additional paths may be added, which provides alternative ways to identify the lowest cost and most efficient path. For example, the initial path described may be changed to (1,0)→(3,0)→(3,1) due to the inclusion of the multi-frame blank symbol to skip over the second frame. In this manner, adding multi-frame blanks adds more potential paths through the lattice, which provides a greater probability that a shorter or more efficient path (e.g., a path with a lower cost) can be identified in order to reduce processing time or resource use.

In at least one embodiment, it may be desirable to encourage or otherwise drive the system toward incorporating multi-frame blank symbols. For example, over a given set of frames, a big blank (e.g., a blank corresponding to at least two spaces) may occur less frequently than a standard blank. Furthermore, a bigger blank (e.g., a blank corresponding to at least three spaces) may be even less frequent. Accordingly, systems and methods may encourage big blank emissions by under-normalizing an output distribution, as shown below:

P(BB|₀)+P(SB|₀)P(SB|₁)

For example, a small positive float may be set, such as 0.05, to drive the model to prioritize using a big blank over a standard blank and/or over two standard blanks. In the example where the float is set at 0.05, the probability of using a big blank is approximately 0.95, which is greater than the probability of using the small blanks of approximately 0.9025. Accordingly, adjustments can be made to the model to add additional big blanks (or bigger blanks) which may encourage skipping more frames to provide fewer output frames for inferencing, which can improve processing times and reduce resource use.

Embodiments of the present disclosure may incorporate dynamic adjustments to training over time. For example, m may change during training such that a first portion of a training process may include m=2 while a second portion may include m=3. Such a change may be linear (e.g., after a given period of time) or may be randomly implemented, among other options. Additionally, in various embodiments, certain thresholds may trigger adjustments to m. Furthermore, the normalization may also change to preferentially apply big blanks or small blanks during different parts of the training process. In at least one embodiment, one or more training metrics may be evaluated and then different aspects of the training may be adjusted based, at least in part, on those training metrics.

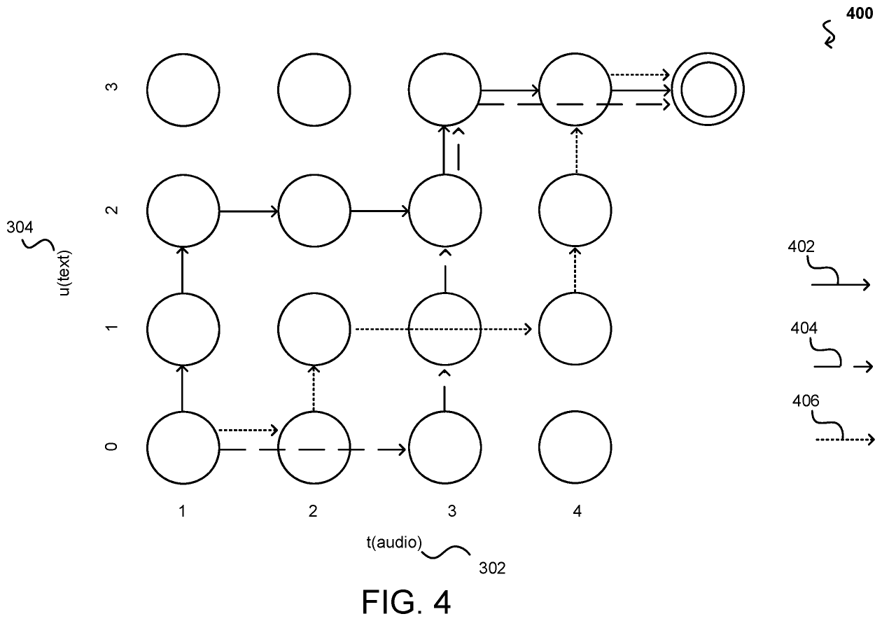

FIG. 4 is a representation of a probability lattice 400 illustrating paths having variable blanks that may be used to implement the present disclosure. In this example, a first path 402 does not include multi-frame blanks, a second path 404 includes at least one multi-frame blank, and a third path 406 includes multi-frame blanks having different sizes m. These illustrated paths provide examples of traversal through the lattice and are not intended to represent each potential path.

Starting with the first path 402 (represented by the solid arrows), a traditional RNN-T model may implement a traversal that evaluates each frame 302 subsequently. For example, starting at (1,0), the first path 402 includes different segments through the lattice corresponding to (1,0)→(1,1)→(1, 2)→(2,2)→(3,2)→(3,3)→(4,3)→end. Accordingly, there are 7 different segments and each of frames 1-4 are evaluated during the segments. As shown along the first path 402, there are two instances where two standard blanks (e.g., blanks of size m=1) are used. As a result, this path includes probabilities associated with at least one frame that may not provide meaningful results when evaluated at inferencing, but is still including the probability calculation of the path, which may lead to a path that has a higher cost. Even if selected, the first path 402 may cause additional processing during inferencing that will increase time and resource use to execute over a frame that is essentially skipped.

The second path 404 (represented by the large dash arrows) overcomes these problems by implementing at least one multi-frame blank. For example, the second path 404 also starts at (1,0), but includes different segments through the lattice corresponding to (1,0)→(3,0)→(3,1)→(3,2)→(3,3)→end. As shown, the second path 404 skips both the second frame and the fourth frame, which may lead to providing fewer frames for inferencing.

The third path 406 (represented by the small dash arrows) provides an example where different sized blanks may be included within a single path. For example, the third path 406 includes different segments through the lattice corresponding to (1,0)→(2,0)→(2,1)→(4,1)→(4,2)→(4,3)→end. In this example, frame three is skipped using the multi-frame blank symbol, however, standard blanks are also used throughout the path. Accordingly, systems and methods may include combinations of different blanks in order to generate different types of paths, thereby increasing a number of paths through the lattice to facilitate learning of a most efficient path.

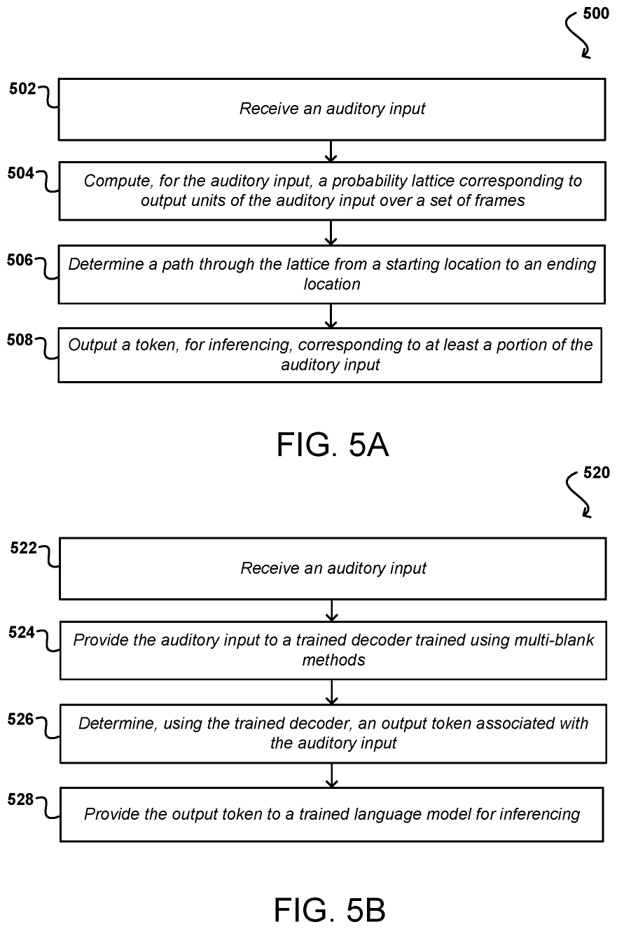

FIG. 5A illustrates an example process 500 for generating a token for an auditory input. It should be understood that for this and other processes presented herein that there can be additional, fewer, or alternative operations performed in similar or alternative order, or at least partially in parallel, within the scope of various embodiments unless otherwise specifically stated. In this example, an auditory input is received 502. The auditory input may correspond to a user utterance provided to an ASR system. For example, the ASR system may include one or more trained subsystems to receive and process the auditory input in order to generate a textual output.

In at least one embodiment, a probability lattice is computed for the auditory input 504. The probability lattice may be computed as part of a training phase, for example for a decoder of the ASR system. The probability lattice may include a set of frames corresponding to the auditory input and also a probability that different output units are associated with the different frames. A path through the lattice may be determined 506, where the path may start at a first location and traverse the lattice to an end location corresponding to a prediction for one or more portions so the auditory input. The path may include vertical movement between different output units and horizontal movement between different frames of the auditory input. In at least one embodiment, horizontal movement includes a multi-frame blank that skips two or more frames upon determining that the frame either has no sound, such as a pause, or determining that the frame is a continuation of a previously determined output unit. A number of potential paths may be determined through the lattice and a probability of sums may be computed along these paths to identify a path with the lowest cost.

An output token may be generated for inferencing 508, where the output token corresponds to different letters, sub words, phonemes, or the like associated with the auditory input. This output token may then be evaluated against a ground truth and a training phase for the ASR system may be repeated. The output tokens may also include blank and/or multi-blank tokens, such that the model not only learns when to output a token for a given letter, word, sub word, phoneme, etc., and what token to output, but also learns when to output a token for a blank, a multi-blank, etc., as well as what blank-type token to output (e.g., one blank, double blank, triple blank, etc., depending on the embodiment and the different blanks that the model is trained for).

FIG. 5B illustrates an example process 520 for providing a token to a trained language model for inferencing. In this example, an auditory input is received 522 and provided to a trained decoder 524. The decoder may be trained using one or more multi-frame blank methods where a probability lattice is traversed across two or more frames when generating a path through the lattice. In at least one embodiment, training may include establishing a multi-frame blank symbol corresponding to m frames. The number of frames may be adjusted during training and/or may be modified dynamically based on different training metrics, user preferences, or the like. The trained decoder may provide an output token 526 that is provided to a trained language model for inferencing 528.

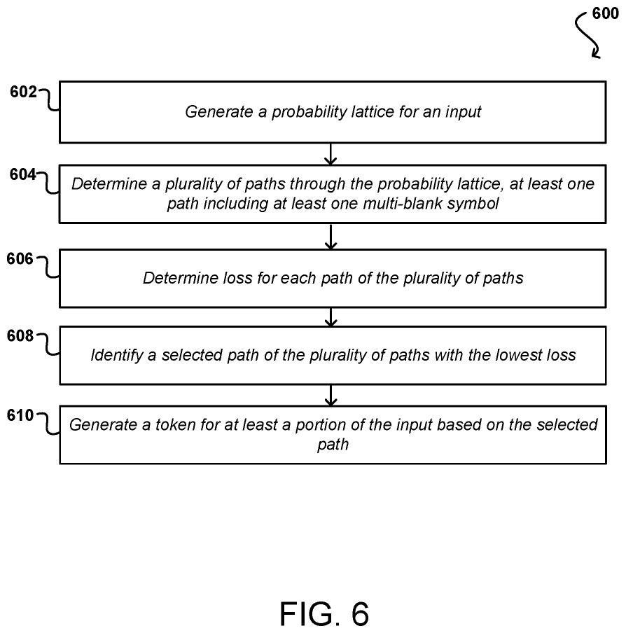

FIG. 6 illustrates an example process 600 for processing an input through a probability lattice. In this example, a probability lattice is generated for an input 602. The probability lattice may include a number of frames corresponding to a period of time of the input and may also include output units for different portions of the input, such as different letters, phonemes, and/or the like. A plurality of paths may be determined through the lattice 604, where the paths may traverse the lattice to get from a first location to an end location. At least one path of the plurality of paths may include a multi-frame blank symbol which correspond to a traversal where at least two frames are traversed. A loss for each path may be determined 606 and then a path with the lowest loss may be selected 608. A token may then be generated based on the selected path 610.

Data Center

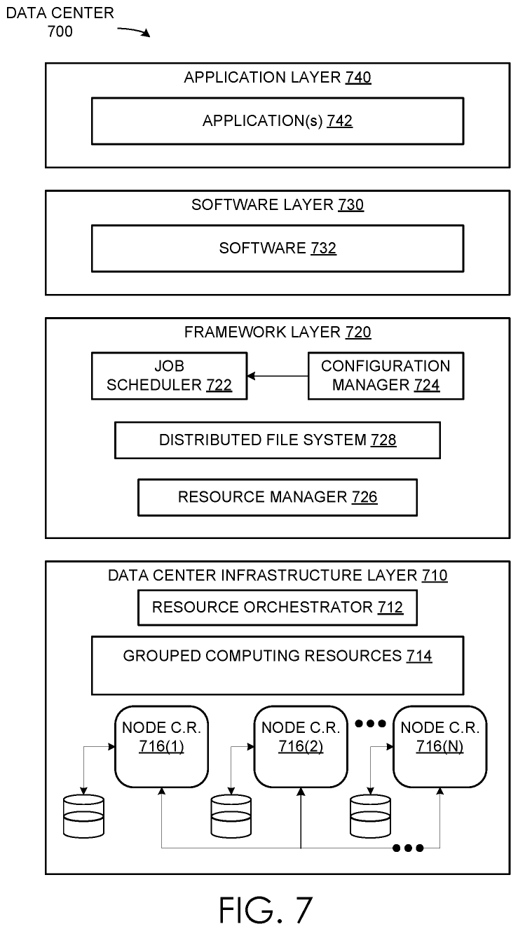

FIG. 7 illustrates an example data center 700, in which at least one embodiment may be used. In at least one embodiment, data center 700 includes a data center infrastructure layer 710, a framework layer 720, a software layer 730, and an application layer 740.

In at least one embodiment, as shown in FIG. 7, data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 716(1)-716(N) may be a server having one or more of above-mentioned computing resources.

In at least one embodiment, grouped computing resources 714 may include separate groupings of node C.R.s housed within one or more racks (not shown), or many racks housed in data centers at various geographical locations (also not shown). Separate groupings of node C.R.s within grouped computing resources 714 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 712 may configure or otherwise control one or more node C.R.s 716(1)-716(N) and/or grouped computing resources 714. In at least one embodiment, resource orchestrator 712 may include a software design infrastructure (“SDI”) management entity for data center 700. In at least one embodiment, resource orchestrator may include hardware, software or some combination thereof.

In at least one embodiment, as shown in FIG. 7, framework layer 720 includes a job scheduler 722, a configuration manager 724, a resource manager 726 and a distributed file system 728. In at least one embodiment, framework layer 720 may include a framework to support software 732 of software layer 730 and/or one or more application(s) 742 of application layer 740. In at least one embodiment, software 732 or application(s) 742 may respectively include web-based service software or applications, such as those provided by Amazon Web Services, Google Cloud and Microsoft Azure. In at least one embodiment, framework layer 720 may be, but is not limited to, a type of free and open-source software web application framework such as Apache Spark™ (hereinafter “Spark”) that may utilize distributed file system 728 for large-scale data processing (e.g., “big data”). In at least one embodiment, job scheduler 722 may include a Spark driver to facilitate scheduling of workloads supported by various layers of data center 700. In at least one embodiment, configuration manager 724 may be capable of configuring different layers such as software layer 730 and framework layer 720 including Spark and distributed file system 728 for supporting large-scale data processing. In at least one embodiment, resource manager 726 may be capable of managing clustered or grouped computing resources mapped to or allocated for support of distributed file system 728 and job scheduler 722. In at least one embodiment, clustered or grouped computing resources may include grouped computing resource 714 at data center infrastructure layer 710. In at least one embodiment, resource manager 726 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 728 of framework layer 720. The one or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 728 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 724, resource manager 726, and resource orchestrator 712 may implement any number and type of self-modifying actions based on any amount and type of data acquired in any technically feasible fashion. In at least one embodiment, self-modifying actions may relieve a data center operator of data center 700 from making possibly bad configuration decisions and possibly avoiding underutilized and/or poor performing portions of a data center.

In at least one embodiment, data center 700 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 700. In at least one embodiment, trained machine learning models corresponding to one or more neural networks may be used to infer or predict information using resources described above with respect to data center 700 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Such components can be used for traversing a probability lattice for an ASR system.

Computer Systems

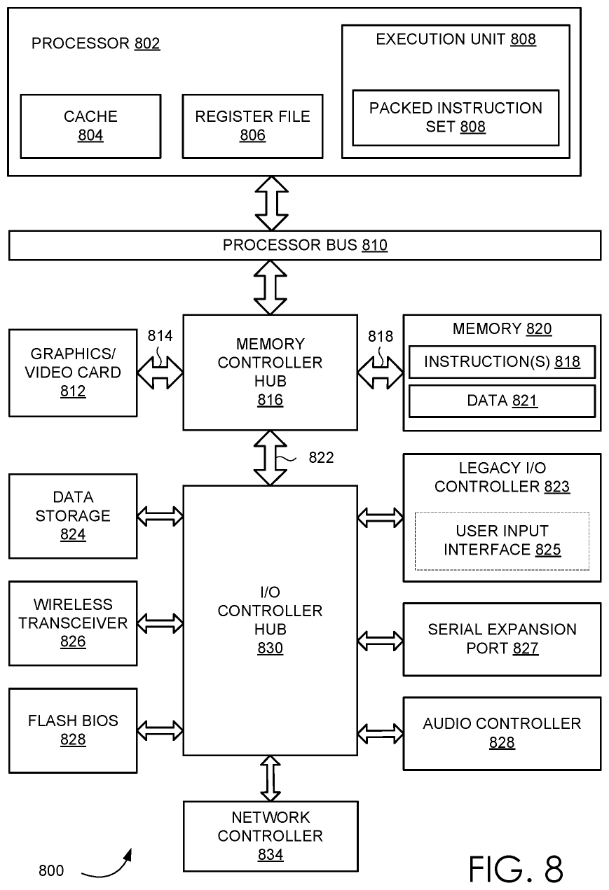

FIG. 8 is a block diagram illustrating an exemplary computer system, which may be a system with interconnected devices and components, a system-on-a-chip (SOC) or some combination thereof 800 formed with a processor that may include execution units to execute an instruction, according to at least one embodiment. In at least one embodiment, computer system 800 may include, without limitation, a component, such as a processor 802 to employ execution units including logic to perform algorithms for process data, in accordance with present disclosure, such as in embodiment described herein. In at least one embodiment, computer system 800 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 800 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), edge computing devices, set-top boxes, network hubs, wide area network (“WAN”) switches, or any other system that may perform one or more instructions in accordance with at least one embodiment.

Embodiments of the systems and methods described herein may be used for a variety of purposes, by way of example and without limitation, for machine control, machine locomotion, machine driving, synthetic data generation, digital twinning, model training, perception, augmented reality, virtual reality, mixed reality, robotics, security and surveillance, autonomous or semi-autonomous machine applications, deep learning, environment simulation, data center processing, conversational AI, light transport simulation (e.g., ray-tracing, path tracing, etc.), collaborative content creation for 3D assets, cloud computing and/or any other suitable applications.

Disclosed embodiments may be incorporated or integrated in a variety of different systems such as automotive systems (e.g., a human-machine interface for an autonomous or semi-autonomous machine), systems implemented using a robot, aerial systems, medial systems, boating systems, smart area monitoring systems, systems for performing deep learning operations, systems for performing simulation and digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

In at least one embodiment, computer system 800 may include, without limitation, processor 802 that may include, without limitation, one or more execution units 808 to perform machine learning model training and/or inferencing according to techniques described herein. In at least one embodiment, computer system 800 is a single processor desktop or server system, but in another embodiment computer system 800 may be a multiprocessor system. In at least one embodiment, processor 802 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 802 may be coupled to a processor bus 810 that may transmit data signals between processor 802 and other components in computer system 800.

In at least one embodiment, processor 802 may include, without limitation, a Level 1 (“L1”) internal cache memory (“cache”) 804. In at least one embodiment, processor 802 may have a single internal cache or multiple levels of internal cache. In at least one embodiment, cache memory may reside external to processor 802. Other embodiments may also include a combination of both internal and external caches depending on particular implementation and needs. In at least one embodiment, register file 806 may store different types of data in various registers including, without limitation, integer registers, floating point registers, status registers, and instruction pointer register.

In at least one embodiment, execution unit 808, including, without limitation, logic to perform integer and floating point operations, also resides in processor 802. In at least one embodiment, processor 802 may also include a microcode (“ucode”) read only memory (“ROM”) that stores microcode for certain macro instructions. In at least one embodiment, execution unit 808 may include logic to handle a packed instruction set 809. In at least one embodiment, by including packed instruction set 809 in an instruction set of a general-purpose processor 802, along with associated circuitry to execute instructions, operations used by many multimedia applications may be performed using packed data in a general-purpose processor 802. In one or more embodiments, many multimedia applications may be accelerated and executed more efficiently by using full width of a processor's data bus for performing operations on packed data, which may eliminate need to transfer smaller units of data across processor's data bus to perform one or more operations one data element at a time.

In at least one embodiment, execution unit 808 may also be used in microcontrollers, embedded processors, graphics devices, DSPs, and other types of logic circuits. In at least one embodiment, computer system 800 may include, without limitation, a memory 820. In at least one embodiment, memory 820 may be implemented as a Dynamic Random Access Memory (“DRAM”) device, a Static Random Access Memory (“SRAM”) device, flash memory device, or other memory device. In at least one embodiment, memory 820 may store instruction(s) 819 and/or data 821 represented by data signals that may be executed by processor 802.

In at least one embodiment, system logic chip may be coupled to processor bus 810 and memory 820. In at least one embodiment, system logic chip may include, without limitation, a memory controller hub (“MCH”) 816, and processor 802 may communicate with MCH 816 via processor bus 810. In at least one embodiment, MCH 816 may provide a high bandwidth memory path 818 to memory 820 for instruction and data storage and for storage of graphics commands, data and textures. In at least one embodiment, MCH 816 may direct data signals between processor 802, memory 820, and other components in computer system 800 and to bridge data signals between processor bus 810, memory 820, and a system I/O 822. In at least one embodiment, system logic chip may provide a graphics port for coupling to a graphics controller. In at least one embodiment, MCH 816 may be coupled to memory 820 through a high bandwidth memory path 818 and graphics/video card 812 may be coupled to MCH 816 through an Accelerated Graphics Port (“AGP”) interconnect 814.

In at least one embodiment, computer system 800 may use system I/O 822 that is a proprietary hub interface bus to couple MCH 816 to I/O controller hub (“ICH”) 830. In at least one embodiment, ICH 830 may provide direct connections to some I/O devices via a local I/O bus. In at least one embodiment, local I/O bus may include, without limitation, a high-speed I/O bus for connecting peripherals to memory 820, chipset, and processor 802. Examples may include, without limitation, an audio controller 829, a firmware hub (“flash BIOS”) 828, a wireless transceiver 826, a data storage 824, a legacy I/O controller 823 containing user input and keyboard interfaces 825, a serial expansion port 827, such as Universal Serial Bus (“USB”), and a network controller 834. Data storage 824 may comprise a hard disk drive, a floppy disk drive, a CD-ROM device, a flash memory device, or other mass storage device.

In at least one embodiment, FIG. 8 illustrates a system, which includes interconnected hardware devices or “chips”, whereas in other embodiments, FIG. 8 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 800 are interconnected using compute express link (CXL) interconnects.

Such components can be used for traversing a probability lattice for an ASR system.

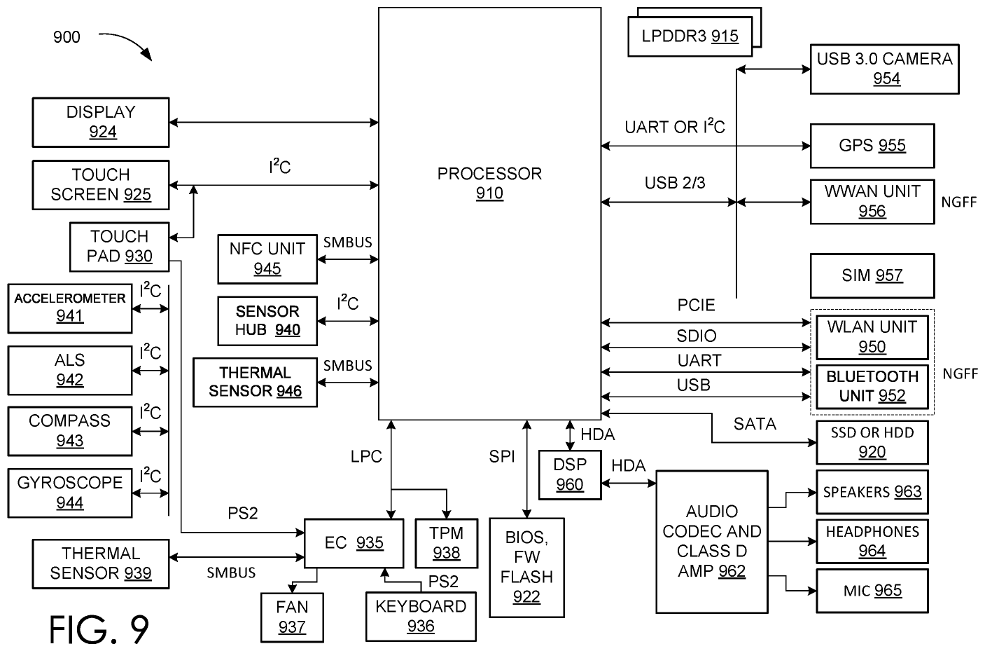

FIG. 9 is a block diagram illustrating an electronic device 900 for utilizing a processor 910, according to at least one embodiment. In at least one embodiment, electronic device 900 may be, for example and without limitation, a notebook, a tower server, a rack server, a blade server, a laptop, a desktop, a tablet, a mobile device, a phone, an embedded computer, or any other suitable electronic device.

In at least one embodiment, system 900 may include, without limitation, processor 910 communicatively coupled to any suitable number or kind of components, peripherals, modules, or devices. In at least one embodiment, processor 910 coupled using a bus or interface, such as a 1° C. bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 9 illustrates a system, which includes interconnected hardware devices or “chips”, whereas in other embodiments, FIG. 9 may illustrate an exemplary System on a Chip (“SoC”). In at least one embodiment, devices illustrated in FIG. 9 may be interconnected with proprietary interconnects, standardized interconnects (e.g., PCIe) or some combination thereof. In at least one embodiment, one or more components of FIG. 9 are interconnected using compute express link (CXL) interconnects.

In at least one embodiment, FIG. 9 may include a display 924, a touch screen 925, a touch pad 930, a Near Field Communications unit (“NFC”) 945, a sensor hub 940, a thermal sensor 946, an Express Chipset (“EC”) 935, a Trusted Platform Module (“TPM”) 938, BIOS/firmware/flash memory (“BIOS, FW Flash”) 922, a DSP 960, a drive 920 such as a Solid State Disk (“SSD”) or a Hard Disk Drive (“HDD”), a wireless local area network unit (“WLAN”) 950, a Bluetooth unit 952, a Wireless Wide Area Network unit (“WWAN”) 956, a Global Positioning System (GPS) 955, a camera (“USB 3.0 camera”) 954 such as a USB 3.0 camera, and/or a Low Power Double Data Rate (“LPDDR”) memory unit (“LPDDR3”) 915 implemented in, for example, LPDDR3 standard. These components may each be implemented in any suitable manner.

In at least one embodiment, other components may be communicatively coupled to processor 910 through components discussed above. In at least one embodiment, an accelerometer 941, Ambient Light Sensor (“ALS”) 942, compass 943, and a gyroscope 944 may be communicatively coupled to sensor hub 940. In at least one embodiment, thermal sensor 939, a fan 937, a keyboard 946, and a touch pad 930 may be communicatively coupled to EC 935. In at least one embodiment, speaker 963, headphones 964, and microphone (“mic”) 965 may be communicatively coupled to an audio unit (“audio codec and class d amp”) 962, which may in turn be communicatively coupled to DSP 960. In at least one embodiment, audio unit 964 may include, for example and without limitation, an audio coder/decoder (“codec”) and a class D amplifier. In at least one embodiment, SIM card (“SIM”) 957 may be communicatively coupled to WWAN unit 956. In at least one embodiment, components such as WLAN unit 950 and Bluetooth unit 952, as well as WWAN unit 956 may be implemented in a Next Generation Form Factor (“NGFF”).

Such components can be used for traversing a probability lattice for an ASR system.

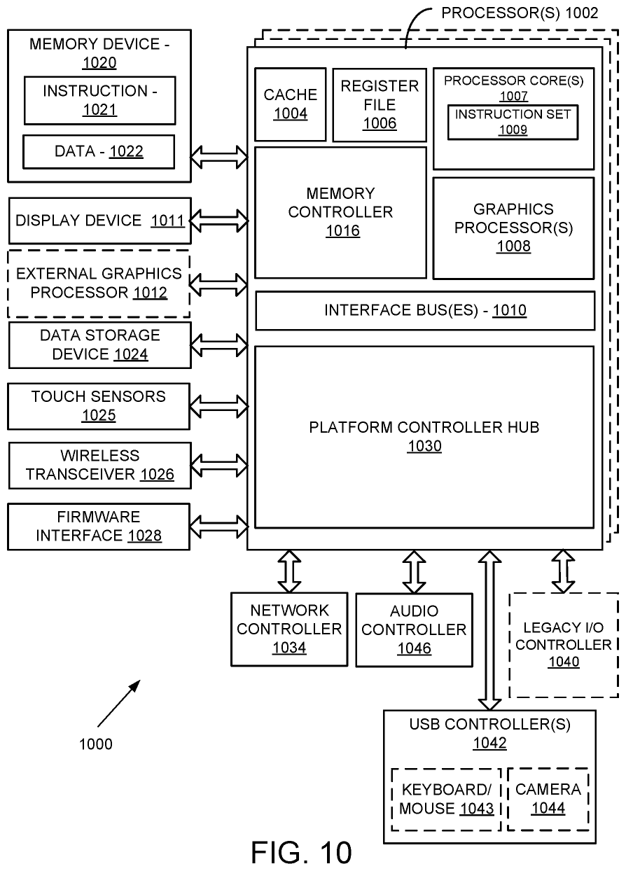

FIG. 10 is a block diagram of a processing system, according to at least one embodiment. In at least one embodiment, system 1000 includes one or more processors 1002 and one or more graphics processors 1008, and may be a single processor desktop system, a multiprocessor workstation system, or a server system or datacenter having a large number of collectively or separably managed processors 1002 or processor cores 1007. In at least one embodiment, system 1000 is a processing platform incorporated within a system-on-a-chip (SoC) integrated circuit for use in mobile, handheld, or embedded devices.

In at least one embodiment, system 1000 can include, or be incorporated within a server-based gaming platform, a cloud computing host platform, a virtualized computing platform, a game console, including a game and media console, a mobile gaming console, a handheld game console, or an online game console. In at least one embodiment, system 1000 is a mobile phone, smart phone, tablet computing device or mobile Internet device. In at least one embodiment, processing system 1000 can also include, couple with, or be integrated within a wearable device, such as a smart watch wearable device, smart eyewear device, augmented reality device, edge device, Internet of Things (“IoT”) device, or virtual reality device. In at least one embodiment, processing system 1000 is a television or set top box device having one or more processors 1002 and a graphical interface generated by one or more graphics processors 1008.

In at least one embodiment, one or more processors 1002 each include one or more processor cores 1007 to process instructions which, when executed, perform operations for system and user software. In at least one embodiment, each of one or more processor cores 1007 is configured to process a specific instruction set 1009. In at least one embodiment, instruction set 1009 may facilitate Complex Instruction Set Computing (CISC), Reduced Instruction Set Computing (RISC), or computing via a Very Long Instruction Word (VLIW). In at least one embodiment, processor cores 1007 may each process a different instruction set 1009, which may include instructions to facilitate emulation of other instruction sets. In at least one embodiment, processor core 1007 may also include other processing devices, such a Digital Signal Processor (DSP).

In at least one embodiment, processor 1002 includes cache memory 1004. In at least one embodiment, processor 1002 can have a single internal cache or multiple levels of internal cache. In at least one embodiment, cache memory is shared among various components of processor 1002. In at least one embodiment, processor 1002 also uses an external cache (e.g., a Level-3 (L3) cache or Last Level Cache (LLC)) (not shown), which may be shared among processor cores 1007 using known cache coherency techniques. In at least one embodiment, register file 1006 is additionally included in processor 1002 which may include different types of registers for storing different types of data (e.g., integer registers, floating point registers, status registers, and an instruction pointer register). In at least one embodiment, register file 1006 may include general-purpose registers or other registers.

In at least one embodiment, one or more processor(s) 1002 are coupled with one or more interface bus(es) 1010 to transmit communication signals such as address, data, or control signals between processor 1002 and other components in system 1000. In at least one embodiment, interface bus 1010, in one embodiment, can be a processor bus, such as a version of a Direct Media Interface (DMI) bus. In at least one embodiment, interface 1010 is not limited to a DMI bus, and may include one or more Peripheral Component Interconnect buses (e.g., PCI, PCI Express), memory busses, or other types of interface busses. In at least one embodiment processor(s) 1002 include an integrated memory controller 1016 and a platform controller hub 1030. In at least one embodiment, memory controller 1016 facilitates communication between a memory device and other components of system 1000, while platform controller hub (PCH) 1030 provides connections to I/O devices via a local I/O bus.

In at least one embodiment, memory device 1020 can be a dynamic random access memory (DRAM) device, a static random access memory (SRAM) device, flash memory device, phase-change memory device, or some other memory device having suitable performance to serve as process memory. In at least one embodiment memory device 1020 can operate as system memory for system 1000, to store data 1022 and instructions 1021 for use when one or more processors 1002 executes an application or process. In at least one embodiment, memory controller 1016 also couples with an optional external graphics processor 1012, which may communicate with one or more graphics processors 1008 in processors 1002 to perform graphics and media operations. In at least one embodiment, a display device 1011 can connect to processor(s) 1002. In at least one embodiment display device 1011 can include one or more of an internal display device, as in a mobile electronic device or a laptop device or an external display device attached via a display interface (e.g., DisplayPort, etc.). In at least one embodiment, display device 1011 can include a head mounted display (HMD) such as a stereoscopic display device for use in virtual reality (VR) applications or augmented reality (AR) applications.

In at least one embodiment, platform controller hub 1030 enables peripherals to connect to memory device 1020 and processor 1002 via a high-speed I/O bus. In at least one embodiment, I/O peripherals include, but are not limited to, an audio controller 1046, a network controller 1034, a firmware interface 1028, a wireless transceiver 1026, touch sensors 1025, a data storage device 1024 (e.g., hard disk drive, flash memory, etc.). In at least one embodiment, data storage device 1024 can connect via a storage interface (e.g., SATA) or via a peripheral bus, such as a Peripheral Component Interconnect bus (e.g., PCI, PCI Express). In at least one embodiment, touch sensors 1025 can include touch screen sensors, pressure sensors, or fingerprint sensors. In at least one embodiment, wireless transceiver 1026 can be a Wi-Fi transceiver, a Bluetooth transceiver, or a mobile network transceiver such as a 3G, 4G, or Long Term Evolution (LTE) transceiver. In at least one embodiment, firmware interface 1028 enables communication with system firmware, and can be, for example, a unified extensible firmware interface (UEFI). In at least one embodiment, network controller 1034 can enable a network connection to a wired network. In at least one embodiment, a high-performance network controller (not shown) couples with interface bus 1010. In at least one embodiment, audio controller 1046 is a multi-channel high definition audio controller. In at least one embodiment, system 1000 includes an optional legacy I/O controller 1040 for coupling legacy (e.g., Personal System 2 (PS/2)) devices to system. In at least one embodiment, platform controller hub 1030 can also connect to one or more Universal Serial Bus (USB) controllers 1042 connect input devices, such as keyboard and mouse 1043 combinations, a camera 1044, or other USB input devices.

In at least one embodiment, an instance of memory controller 1016 and platform controller hub 1030 may be integrated into a discreet external graphics processor, such as external graphics processor 1012. In at least one embodiment, platform controller hub 1030 and/or memory controller 1016 may be external to one or more processor(s) 1002. For example, in at least one embodiment, system 1000 can include an external memory controller 1016 and platform controller hub 1030, which may be configured as a memory controller hub and peripheral controller hub within a system chipset that is in communication with processor(s) 1002.

Such components can be used for traversing a probability lattice for an ASR system.

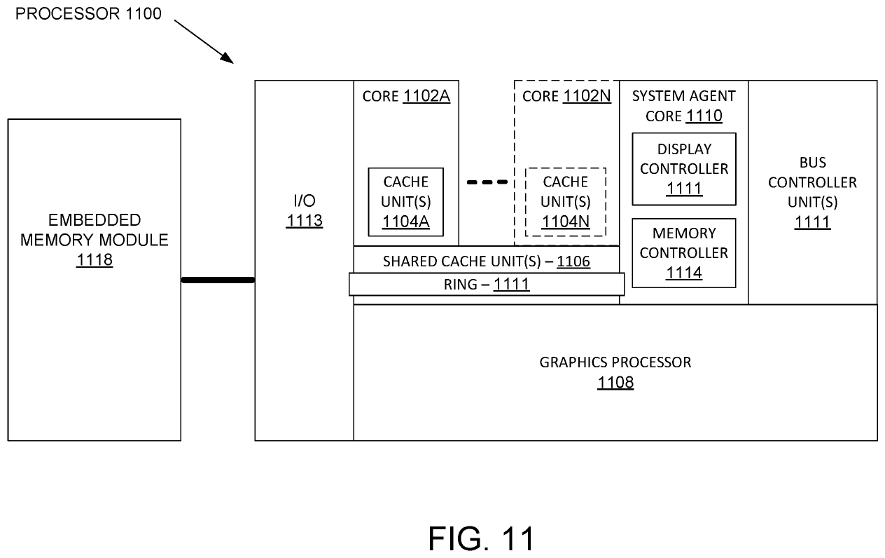

FIG. 11 is a block diagram of a processor 1100 having one or more processor cores 1102A-1102N, an integrated memory controller 1114, and an integrated graphics processor 1108, according to at least one embodiment. In at least one embodiment, processor 1100 can include additional cores up to and including additional core 1102N represented by dashed lined boxes. In at least one embodiment, each of processor cores 1102A-1102N includes one or more internal cache units 1104A-1104N. In at least one embodiment, each processor core also has access to one or more shared cached units 1106.

In at least one embodiment, internal cache units 1104A-1104N and shared cache units 1106 represent a cache memory hierarchy within processor 1100. In at least one embodiment, cache memory units 1104A-1104N may include at least one level of instruction and data cache within each processor core and one or more levels of shared mid-level cache, such as a Level 2 (L2), Level 3 (L3), Level 4 (L4), or other levels of cache, where a highest level of cache before external memory is classified as an LLC. In at least one embodiment, cache coherency logic maintains coherency between various cache units 1106 and 1104A-1104N.

In at least one embodiment, processor 1100 may also include a set of one or more bus controller units 1116 and a system agent core 1110. In at least one embodiment, one or more bus controller units 1116 manage a set of peripheral buses, such as one or more PCI or PCI express busses. In at least one embodiment, system agent core 1110 provides management functionality for various processor components. In at least one embodiment, system agent core 1110 includes one or more integrated memory controllers 1114 to manage access to various external memory devices (not shown).

In at least one embodiment, one or more of processor cores 1102A-1102N include support for simultaneous multi-threading. In at least one embodiment, system agent core 1110 includes components for coordinating and operating cores 1102A-1102N during multi-threaded processing. In at least one embodiment, system agent core 1110 may additionally include a power control unit (PCU), which includes logic and components to regulate one or more power states of processor cores 1102A-1102N and graphics processor 1108.

In at least one embodiment, processor 1100 additionally includes graphics processor 1108 to execute graphics processing operations. In at least one embodiment, graphics processor 1108 couples with shared cache units 1106, and system agent core 1110, including one or more integrated memory controllers 1114. In at least one embodiment, system agent core 1110 also includes a display controller 1111 to drive graphics processor output to one or more coupled displays. In at least one embodiment, display controller 1111 may also be a separate module coupled with graphics processor 1108 via at least one interconnect, or may be integrated within graphics processor 1108.

In at least one embodiment, a ring based interconnect unit 1112 is used to couple internal components of processor 1100. In at least one embodiment, an alternative interconnect unit may be used, such as a point-to-point interconnect, a switched interconnect, or other techniques. In at least one embodiment, graphics processor 1108 couples with ring interconnect 1112 via an I/O link 1113.

In at least one embodiment, I/O link 1113 represents at least one of multiple varieties of I/O interconnects, including an on package I/O interconnect which facilitates communication between various processor components and a high-performance embedded memory module 1118, such as an eDRAM module. In at least one embodiment, each of processor cores 1102A-1102N and graphics processor 1108 use embedded memory modules 1118 as a shared Last Level Cache.

In at least one embodiment, processor cores 1102A-1102N are homogenous cores executing a common instruction set architecture. In at least one embodiment, processor cores 1102A-1102N are heterogeneous in terms of instruction set architecture (ISA), where one or more of processor cores 1102A-1102N execute a common instruction set, while one or more other cores of processor cores 1102A-1102N executes a subset of a common instruction set or a different instruction set. In at least one embodiment, processor cores 1102A-1102N are heterogeneous in terms of microarchitecture, where one or more cores having a relatively higher power consumption couple with one or more power cores having a lower power consumption. In at least one embodiment, processor 1100 can be implemented on one or more chips or as an SoC integrated circuit.

Such components can be used for traversing a probability lattice for an ASR system.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) and/or a data processing unit (“DPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be any processor capable of general purpose processing such as a CPU, GPU, or DPU. As non-limiting examples, “processor” may be any microcontroller or dedicated processing unit such as a DSP, image signal processor (“ISP”), arithmetic logic unit (“ALU”), vision processing unit (“VPU”), tree traversal unit (“TTU”), ray tracing core, tensor tracing core, tensor processing unit (“TPU”), embedded control unit (“ECU”), and the like. As non-limiting examples, “processor” may be a hardware accelerator, such as a PVA (programmable vision accelerator), DLA (deep learning accelerator), etc. As non-limiting examples, “processor” may also include one or more virtual instances of a CPU, GPU, etc., hosted on an underlying hardware component executing one or more virtual machines. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method, comprising:
performing, using a neural network (NN), one or more automatic speech recognition (ASR) operations with respect to a sequence of audio frames, wherein an output of the NN corresponding to at least one audio frame of the sequence of audio frames corresponds to a multi-frame blank, the multi-frame blank causing two or more subsequent audio frames of the sequence of audio frames to be omitted from processing using the NN.

2. The method of claim 1, wherein the NN is trained using a probability lattice representing a probability of interpretations corresponding to a training sequence of input audio frames.

3. The method of claim 1, wherein the NN comprises a recurrent neural network transducer (RNN-T), wherein one or more parameters of the RNN-T are updated based at least on one or more loss functions comprising at least one of: one or more forward weights, one or more backward weights, or a multi-frame probability.

4. The method of claim 3, wherein the multi-frame probability is omitted for boundary conditions.

5. The method of claim 1, wherein the output of the NN includes values corresponding to a plurality of output tokens, and further wherein a highest value of the values of the output corresponds to a multi-frame blank token of the output tokens.

6. The of claim 1, wherein a number of contiguous audio frames corresponding to the multi-frame blank is specified within a configuration file.

7. The method of claim 1, wherein the NN outputs a probability or confidence value for a plurality of output tokens, the plurality of output tokens including a first multi-frame blank token corresponding to a first number of frames and a second multi-frame blank token corresponding to a second number of frames different from the first number of frames.

8. A system comprising:
at least one processor to:
generate a probability lattice corresponding to an auditory utterance over a plurality of frames;
traverse through the probability lattice to generate a plurality of paths, at least one path of the plurality of paths including a multi-frame blank to advance two or more frames through plurality of frames; and
update one or more parameters of a neural network based at least on evaluating the plurality of paths according to one or more loss functions.

9. The system of claim 8, wherein the system comprises at least one of:
a system for performing simulation operations;
a system for performing simulation operations to test or validate autonomous machine applications;
an infotainment system of a machine;
an entertainment system of a machine;
a system for generating synthetic data;
a system for collaborative content creation of multi-dimensional assets;
a system for performing digital twin simulation;
a system for presenting at least one of virtual reality content, augmented reality content, or mixed reality content;
a system for rendering graphical output;
a system for performing deep learning operations;
a system implemented using an edge device;
a system incorporating one or more Virtual Machines (VMs);
a system implemented at least partially in a data center; or
a system implemented at least partially using cloud computing resources.

10. The system of claim 8, wherein the neural network includes a recurrent neural network transducer (RNN-T).

11. The system of claim 8, wherein the evaluating the plurality of paths according to the one or more loss functions includes:
determining forward weights for the plurality of paths;
determining backward weights for the plurality of paths; and
determining, for individual paths of the plurality of paths, a respective path cost of the plurality of paths based at least on the one or more loss functions.

12. The system of claim 8, wherein a number of frames to advance for the multi-frame blank is user-configured.

13. The system of claim 8, wherein a first instance of the neural network is trained using a first number of frames for the multi-frame blank, and a second instance of the neural network is trained using a second number of frames for the multi-frame blank.

14. The system of claim 8, wherein at least one loss function of the one or more loss functions weights the multi-frame blank more heavily than a single frame blank to increase a number of multi-frame blanks output using the neural network in deployment.

15. The system of claim 8, wherein the at least one processor is further to:
identify a boundary condition; and
cause the multi-frame blank to be omitted at the boundary condition.

16. A processor comprising:
one or more processing units to:
compute, using a neural network and based at least on a first frame of an auditory input, an output value indicative of a multi-frame blank token;
based at least on the multi-frame blank token, select, as a next frame for the neural network to process after the first frame, a second frame of the auditory input that is two or more frames subsequent the first frame;
compute, using the neural network and based at least on the second frame, a second output value indicative of a token; and
generate a textual representation of the auditory input based at least in part on the token.

17. The processor of claim 16, wherein the processor is comprised at least one of:
a system for performing simulation operations;
a system for performing simulation operations to test or validate autonomous machine applications;
an infotainment system of a machine;
an entertainment system of a machine;
a system for generating synthetic data;
a system for collaborative content creation of multi-dimensional assets;
a system for performing digital twin simulation;
a system for presenting at least one of virtual reality content, augmented reality content, or mixed reality content;
a system for rendering graphical output;
a system for performing deep learning operations;
a system implemented using an edge device;
a system incorporating one or more Virtual Machines (VMs);
a system implemented at least partially in a data center; or
a system implemented at least partially using cloud computing resources.

18. The system of claim 16, wherein the neural network includes a recurrent neural network transducer (RNN-T).

19. The system of claim 16, wherein the neural network is trained using at least one path through a probability lattice, the at least one path including skipping two or more frames of a training auditory input.

20. The system of claim 16, wherein the output value includes a probability value or a confidence value corresponding to the multi-frame blank token, and the neural network further outputs one or more other probability values or confidence values corresponding to one or more tokens, the one or more tokens corresponding to at least one of characters, letters, words, sub words, or phonemes.
